(19) United States
(12) Patent Application Publication
(10) Pub. No.: US 2015/0348038 A1
(43) Pub. Date: Dec. 3, 2015

(54) Method and Apparatus for Money Transfer to an Account

(71) Applicant: Moneygram International, Inc., Minneapolis, MN (US)

(72) Inventors: Christopher Melvin Donald Femrite, Brooklyn Park, MN (US); Wendi Schlarb, Lucas, TX (US); Zahid Zoebbhai Kalolwala, Dubai (AE); Daniel Fletcher Bontrager, Littleton, CO (US); Kenneth Luk-Pat, Sunrise, FL (US); Janice Chiew Keuk Ong, Dallas, TX (US); Alex Chan Lim, Pasig City (PH); Elena Kuznetsov, Eden Prairie, MN (US); Lisa Marie Minogue, Forest Lake, MN (US)

(73) Assignee: Moneygram International, Inc., Minneapolis, MN (US)

(21) Appl. No.: 14/294,857

(22) Filed: Jun. 3, 2014

(51) Int. Cl. G06Q 20/40; G06Q 20/10

(52) U.S. Cl. CPC G06Q 20/4014; G06Q 20/10

(57) ABSTRACT

A method includes receiving, by a processor, a request to initiate a money transfer transaction between a sending party and a receiving party. The request may include information identifying an account associated with the receiving party. The method includes initiating, by the processor, validation of the account associated with the receiving party. The method includes initiating, by the processor, the money transfer transaction between the sending party and the receiving party in response to a determination that the account associated with the receiving party is valid. Initiation of the money transfer transaction causes funds to be deposited into the account associated with the receiving party.

### TECHNICAL FIELD

The present application relates to systems and methods for initiating and funding money transfer transactions to an account.

### BACKGROUND

Money transfer transactions have become common. For example, a money transfer entity may establish a location, such as a brick and mortar store or a kiosk, and a sending party may visit the location to initiate a money transfer transaction between the sending party and a receiving party. The sending party may provide funds (e.g., cash, payment with a financial card, a prepaid card, etc.) to the money transfer entity, and a the receiving party may receive the funds from another location of the money transfer entity (e.g., at a remote location). Verification that the funds from the sending party have been received prior to providing the funds to the receiving party at the remote money transfer location is important, since many money transfer transactions involve distribution of cash to the receiving party.

In order to provide further services to money transfer customers, other types of money transaction have also been created, such as cash to account (C2A) transactions, where the sending party provides funds to the money transfer entity and the money transfer entity then coordinates the deposit of the funds into an account associated with the receiving party. Such transactions, however, require precise information to be captured in order to correctly and efficiently implement the transaction. Further, this information may be confidential to one or more parties and should not necessarily be freely provided to other parties of a transaction or the money transfer service itself.

### BRIEF SUMMARY

The present disclosure provides for systems, methods, and computer-readable storage devices providing cash to account (C2A) money transfer transactions. One or more aspects of the present disclosure may facilitate initiation of, processing or, and/or funding of C2A money transfer transaction between a sending party and a receiving party even when the sending party provides information associated with an invalid account or otherwise fails to identify an account of the receiving party. In an aspect, the systems methods and computer readable storage devices of the present disclosure facilitate real-time account validation in connection with C2A money transfer transactions, and creation of a new account when account information provided by a sending party identifies an invalid account. Thus, one or more aspects of the present disclosure enable completion of C2A money transfer transactions in real-time even when the sending party does not provide valid account information.

In some aspects, funds from a money transfer transaction may be deposited directly into a receiving party's account in real time from a bank account associated with a money transfer service. Accordingly, a money transfer transaction may be initiated and the sending party's funds received in one or more locations, such as an agent location, a sending party's computing device, and the like. Upon the money transfer service receiving the funds, instead of requiring a transfer of funds to an account at a bank, an existing bank account associated with the money transfer service may provide the funds to the receiving party's account, thereby providing for a real time funding of the money transfer transaction.

In accordance with an exemplary aspect, a method includes receiving, by a processor, a request to initiate a money transfer transaction between a sending party and a receiving party. The request may include information identifying an account associated with the receiving party. The method includes initiating, by the processor, validation of the account associated with the receiving party. The method includes initiating, by the processor, the money transfer transaction between the sending party and the receiving party in response to a determination that the account associated with the receiving party is valid. Initiation of the money transfer transaction causes funds to be deposited into the account associated with the receiving party.

In accordance with another exemplary aspect, a system includes a processor, and a memory coupled to the processor. The memory stores instructions that, when executed by the processor, cause the processor to perform operations that include receiving a request to initiate a money transfer transaction between a sending party and a receiving party. The request includes information identifying an account associated with the receiving party. The operations include initiating validation of the account associated with the receiving party, and, in response to a determination that the account associated with the receiving party is valid, initiating the money transfer transaction between the sending party and the receiving party. Initiation of the money transfer transaction causes funds to be deposited into the account associated with the receiving party.

In accordance with yet another exemplary aspect, a computer-readable storage device stores instructions that, when executed by a processor, cause the processor to perform operations that include receiving a request to initiate a money transfer transaction between a sending party and a receiving party. The request includes information identifying an account associated with the receiving party. The operations include initiating validation of the account associated with the receiving party, and, in response to a determination that the account associated with the receiving party is valid, initiating the money transfer transaction between the sending party and the receiving party. Initiation of the money transfer transaction causes funds to be deposited into the account associated with the receiving party.

In accordance with an additional exemplary aspect, a computer-readable storage device stores instructions that, when executed by a processor, cause the processor to perform operations that include presenting, at a display device of an electronic device, a user interface that includes a selectable option to initiate a money transfer transaction between a sending party and a receiving party. The operations include receiving an input corresponding to a request to initiate a first money transfer transaction between a first sending party and a first receiving party. The request may include information identifying an account associated with the first receiving party. The operations include initiating validation of the account associated with the first receiving party, and, in response to a determination that the account associated with the receiving party is valid, initiating the money transfer transaction between the first sending party and the first receiving party. Initiation of the first money transfer transaction causes funds to be deposited into the account associated with the first receiving party.

In yet another aspect, a computer-readable storage device stores instructions that, when executed by a processor, cause the processor to perform operations that include receiving, from a money transfer entity, an account validation request. The account validation request may be received in connection with a money transfer transaction between a sending party and a receiving party, and may include candidate account information associated with an account associated with the receiving party. The operations include validating the candidate account information based on whether the account associated with the receiving party exists, and transmitting, to the money transfer entity, validation information that includes an indication of whether the account with the receiving party exists. The operations may include, subsequent to transmission of validation information indicating that the account with the receiving party does not exist, receiving a request to create a new account based on the candidate account information.

The foregoing has outlined rather broadly the features and technical advantages of the present invention in order that the detailed description that follows may be better understood. Additional features and advantages will be described hereinafter which form the subject of the claims. It should be appreciated by those skilled in the art that the conception and specific embodiment disclosed may be readily utilized as a basis for modifying or designing other structures for carrying out the same purposes of the present application. It should also be realized by those skilled in the art that such equivalent constructions do not depart from the spirit and scope of the application as set forth in the appended claims. The novel features which are believed to be characteristic of embodiments described herein, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present embodiments.

### BRIEF DESCRIPTION OF THE DRAWINGS

For a more complete understanding, reference is now made to the following descriptions taken in conjunction with the accompanying drawings, in which:

FIG. 1 is a block diagram of an exemplary system for initiating, processing, and funding a money transfer transaction;

FIG. 2 is a flow chart illustrating aspects of an exemplary method for performing a money transfer transaction at an agent device;

FIG. 3 is a flow chart illustrating exemplary aspects of a method of initiating a money transfer transaction from a sending party device; and

FIG. 4 is a flow chart illustrating aspects of an exemplary method for creating an account in connection with a money transfer transaction.

### DETAILED DESCRIPTION

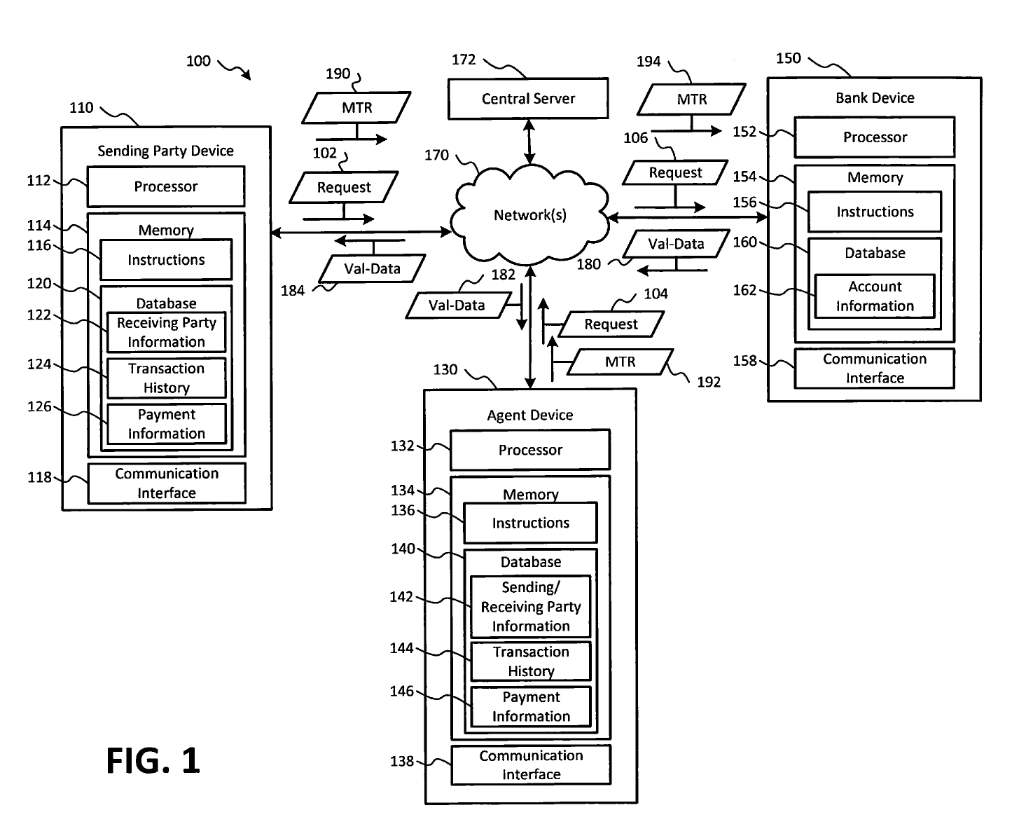

Referring to FIG. 1, a block diagram of an exemplary system for initiating, processing, and funding a money transfer transaction is shown and designated 100. As shown in FIG. 1, the system 100 includes a sending party device 110, an agent device 130, a banking device 150, and a central server 172. The sending party device 110, includes a processor 112, a memory 114, and a communication interface 118. The memory 114 may include read only memory (ROM) devices, random access memory (RAM) devices, one or more hard disk drives (HDDs), flash memory devices, solid state drives (SSDs), other devices configured to store data in a persistent or non-persistent state, or a combination of different memory devices. The memory 114 may store instructions 116 that, when executed by the processor 112, cause the processor 112 to perform operations described in connection with the sending party device 110 with reference to FIGS. 1-4.

The communication interface 118 may be configured to communicatively couple the sending party device 110 to one or more networks, such as a network 170, as shown in FIG. 1. The communication interface 118 may be configured to communicatively couple the sending party device 110 to the network 170 via a wired or wireless connection established according to one or more communication protocols or standards (e.g., an Ethernet protocol, a transmission control protocol/internet protocol (TCP/IP), an institute of electrical and electronics engineers (IEEE) 802.11 protocol, and an IEEE 802.16 protocol, a 3^{rd} generation (3G) protocol, a 4^{th} generation (4G) protocol, a long term evolution (LTE) protocol, etc.).

The network 170 may be a wired network, a wireless network, or may include a combination of wired and wireless networks. For example, the network 170 may be a local area network (LAN), a wide area network (WAN), a wireless WAN, a wireless LAN (WLAN), a metropolitan area network (MAN), a wireless MAN network, a cellular data network, a cellular voice network, the internet, etc. Additionally, the network 170 may include multiple networks operated by different entities. For example, the network 170 may include a first network (e.g., a payment processing network) operated by a first network operator (e.g., a financial card payment processing entity, a credit card company, a bank, an automatic clearing house (ACH) entity, another type of financial entity, etc.) and a second network (e.g., a LAN, WAN, WLAN, wireless WAN, etc.) operated by a second operator (e.g., a money transfer agent, an operator of a chain of grocery stores, a fueling station, an operator of a chain of fueling stations, etc.). The sending party device 110 may communicate with the agent device 130 and/or the bank device 150 via the connection to the network 170.

As shown in FIG. 1, the agent device 130 includes a processor 132, a memory 134, and a communication interface 138. The memory 134 may include ROM devices, RAM devices, one or more HDDs, flash memory devices, SSDs, other devices configured to store data in a persistent or non-persistent state, or a combination of different memory devices. The memory 134 may store instructions 136 that, when executed by the processor 132, cause the processor 132 to perform operations described in connection with the agent device 130 with reference to FIGS. 1-4. The communication interface 138 may be configured to communicatively couple the agent device 130 to one or more networks, such as the network 170, as shown in FIG. 1. The communication interface 138 may be configured to communicatively couple the agent device 130 to the network 170 via a wired or wireless connection established according to one or more communication protocols or standards (e.g., an Ethernet protocol, a TCP/IP protocol, IEEE 802.11 protocol, and an IEEE 802.16 protocol, a 3G protocol, a 4G protocol, an LTE protocol, etc.).

In an aspect, the agent device 130 may be a laptop computing device, a personal computing device, a tablet computing device, a point of sale (POS) device, a handheld POS device, a smartphone, a mobile communication device, or any other electronic device operable to perform the operations of the agent device 130, as described with reference to FIGS. 1-4. The agent device 130 may include or may be coupled to one or more peripheral devices (not shown in FIG. 1). For example, the one or more peripheral devices may include a money order printer, an identification capture device (e.g., a signature pad, a camera, a pin pad module, a financial card reader, a biometric scanner, etc.), a receipt printer, another printing device, a barcode scanner, a metering device, a weight sensor, a check reader, etc.

As shown in FIG. 1, the bank device 150 includes a processor 152, a memory 154, and a communication interface 158. The memory 154 may include ROM devices, RAM devices, one or more HDDs, flash memory devices, SSDs, other devices configured to store data in a persistent or non-persistent state, or a combination of different memory devices. The memory 154 may store instructions 156 that, when executed by the processor 152, cause the processor 152 to perform operations described in connection with the bank device 150 with reference to FIGS. 1-4. The communication interface 158 may be configured to communicatively couple the bank device 150 to one or more networks, such as the network 170, as shown in FIG. 1. The communication interface 158 may be configured to communicatively couple the bank device 150 to the network 170 via a wired or wireless connection established according to one or more communication protocols or standards (e.g., an Ethernet protocol, a TCP/IP protocol, IEEE 802.11 protocol, and an IEEE 802.16 protocol, a 3G protocol, a 4G protocol, an LTE protocol, etc.).

In an aspect, the bank device 150 may be a laptop computing device, a personal computing device, a tablet computing device, a POS device, a handheld POS device, a smartphone, a mobile communication device, or any other electronic device operable to perform the operations of the bank device 150, as described herein with reference to FIGS. 1-4. The bank device 150 may include or may be coupled to one or more peripheral devices (not shown in FIG. 1). For example, the one or more peripheral devices may include a money order printer, an identification capture device (e.g., a signature pad, a camera, a pin pad module, a financial card reader, a biometric scanner, etc.), a receipt printer, another printing device, a barcode scanner, a metering device, a weight sensor, a check reader, etc. The bank device 150 may process banking transactions (e.g., deposits to and withdrawals from accounts of customers of a bank entity, wire transfers, account-to-account transfers between different accounts within the banking entity, account-to account transfers between an account of the banking entity and an account of another entity, etc.), or may be coupled to a device that processes and executes the banking transactions.

During operation, a money transfer entity may facilitate money transfer transactions using the agent device 130. For example, the money transfer entity may operate multiple money transfer locations operating in different geographical locations (e.g., different areas within a single city, different cities, different states, different countries, etc.). The money transfer transactions may facilitate payment, by a sending party (e.g., a user of the sending party device 110), of funds to the money transfer entity at a first money transfer location. Subsequently, the money transfer entity may provide payment of the funds, less a transaction fee, to a receiving party located at a second money transfer location. The first money transfer location may be the same or different (e.g., different cities, different locations within a same city, different states, different countries, etc.) from the second money transfer location.

In some instances the money transfer entity may provide the sending party with a code or other unique identifier that the sending party may communicate to the receiving party, and the receiving party may present the code or the other unique identifier to the money transfer entity at the second location to authorize the payment of the funds to the receiving party. Presumably, only the sending party could have provided the code to the receiving party. Thus, the presentation of the code or the other unique identifier may be used to verify the identity of the receiving party. In an aspect, the central server 172 may facilitate the authentication of the code or the other unique identifier (e.g., from a database (not shown in FIG. 1) stored at a memory (not shown in FIG. 1) of the central server 172, by communicating with the first agent device 130, etc.). In another aspect, the second agent device 130 may facilitate the authentication by communicating with the first agent device 130 over the network 170 (e.g., via a private network, etc.), rather than the central server 172. Typically, in such money transfer transactions, payment of the funds to the receiving party, once authorized at the second money transfer location, is made in cash, and may take a few minutes or a few days to complete, depending on the method used to communicate the code or the other unique identifier from the sending party to the receiving party, the respective locations of the first and second money transfer locations, the amount of money being transferred from the sending party to the receiving party, etc.

In some instances, the money transfer entity may provide the funds to the receiving party by depositing the funds into an account (e.g., a bank account) associated with the receiving party. Such transactions may be referred to as cash to account (C2A) transactions. In a C2A transaction using presently available systems, a registered receiver number (RRN) is manually created at the agent device 130 (e.g., at a POS device). The RRN may be associated with a user profile (e.g., a profile of the sending party or the receiving party) and may include bank account information associated with a bank account associated with the receiving party, and funds provided by the sending party may be deposited into the account by the money transfer entity using the bank account information provided during the creation of the RRN. In some instances, due to the manual entry of the RRN information (e.g., the bank account information, the profile information, etc.), the C2A transaction may be initiated with incorrect information, causing the C2A transaction to fail.

In some instances, the failure of the C2A transaction may result in no deposit of funds into the account, such as, for example, when the bank account information included in the RRN or in the profile identifies an invalid bank account number, an incorrect bank entity, etc. In other instances, the failure of the C2A transaction may result in the funds being deposited into a wrong account, such as, for example, when the bank account number identified based on the RRN is a valid bank account number for the identified bank entity, but is not a bank account associated with the receiving party. In still other instances, the receiving party may not have an account at the bank entity indicated by the RRN information. Thus, when the C2A transactions fail, the receiving party is unable to receive the funds from the money transfer transaction.

Such failures must be corrected manually and may take days to correct, resulting in the dissatisfaction of customers of the money transfer entity, resulting in delays in providing the funds to the receiving party, and resulting in additional work/lost productivity for the money transfer entity. The inventor has recognized that approximately thirteen percent (13%) of presently executed C2A transactions are initiated with incorrect information, causing the C2A transactions to fail for one or more of the reasons listed above or other reasons. One or more aspects of the present application provide systems and methods that provide real-time account validation for C2A transactions, thus reducing a likelihood that a C2A transaction, once initiated, will fail or otherwise cause delays in providing the funds to the receiving party in connection with a money transfer transaction. Additionally, one or more aspects of the systems and methods disclosed herein may facilitate real-time C2A transactions despite a sending party providing invalid bank account information.

The system 100 may receive a request to initiate a money transfer transaction between a sending party and a receiving party. In an aspect, the system 100 may receive the request from the sending party device 110. For example, the sending party device 110 may include an application that may be stored in the memory 114 as the instructions 116. The instructions 116 may include instructions that cause the processor 112 to present a user interface of the application at a display device of the sending party device 110 (not shown in FIG. 1). The user interface may include a selectable option to initiate a money transfer transaction (e.g., a C2A transaction) between the sending party (e.g., a user of the sending party device 110) and the receiving party from the sending party device 110. The application may receive, via the user interface, an input corresponding to a request to initiate a first money transfer transaction between the sending party and the first receiving party. In response to the input, the sending party device 110 may generate a request 102. In an aspect, the application executed at the sending party device 110 may be a web browser and the user interface may be a web page.

In an additional or alternative aspect, the request may be received at the agent device 130. For example, the sending party may visit a money transfer location and an employee of the money transfer entity may operate the agent device 130 at the direction of the sending party to initiate the money transfer transaction (e.g., the C2A transaction). The sending party may provide information (e.g., a name of the receiving party, account information associated with the receiving party, etc.) to the employee, and the employee may enter the information to the agent device 130 to generate a request 104.

The request (e.g., the request 102 or the request 104) may include information identifying an account (e.g., candidate account information) associated with the receiving party. In response to generating the request, the sending party device 110 or the agent device 130 may initiate validation of an account associated with the receiving party. For example, the request may be transmitted to the bank device 150, and may be configured to cause the bank device 150 to determine whether the candidate account information identifies a valid account at the banking entity.

The request may be received at the bank device 150 as a request 106. The bank device 150 may determine whether the candidate account information identifies a valid account based on information stored in a database. For example, a database 160 may be stored at the memory 154 of the bank device 150. The database 160 may include account information 162. The account information 162 may include one or more entries identifying customers having accounts at a banking entity operating the bank device 150. In an aspect, the database 160 may be stored at a device external to the bank device 150, such as a distributed database stored across a plurality of storage devices which may be collocated or geographically distributed. The bank device 150 may be configured to provide account authorization/validation services for the banking entity and one or more third parties, such as the money transfer entity.

The bank device 150 may be configured to determine, based on the candidate account information included in the request 106 and the account information 162, whether the account associated with the receiving party is a valid account. A valid account may be indicated when an account number included in the candidate account information matches an account number identified based on the account information 162. Additionally or alternatively, a valid account may be indicated when the name of the receiving party matches a name associated with the matching account number in the account information 162. The candidate account information may include additional information (e.g., an address associated with the receiving party, a routing number associated with the banking entity, etc.) that may be cross-referenced with the account information 162 to perform account validations in response to requests, such as the request 106.

Based on the account validity determination, the bank device 150 may generate validation information that includes an indication of whether the account with the receiving party is a valid account at the banking entity. For example, when the candidate account information indicates a valid account number, but the name of the receiving party does not match a name of an account holder associated with the account identified by the account number, the validation information may indicate an invalid account. As an additional example, when the candidate account information indicates an invalid account number (e.g., an account number that does not match an account number at the banking entity), the validation information may indicate an invalid account. When the candidate account information includes an account number matching an account number at the banking entity and the name of the receiving party, as indicated in the candidate account information, matches an entry in the account information 162, the validation information may indicate a valid account (e.g., an account corresponding to the candidate account information exists at the banking entity).

In an aspect, the validation information may include error codes or other descriptive indicators indicating a reason that the validation information indicates an invalid account. For example, when the account number indicated in the candidate account information exists (e.g., matches an account number of an entry in the account information 162), but the name of the receiving party does not match a name of an account holder corresponding to the account number, the validation information may include information indicating a name mismatch. When the account number indicated in the candidate account information does not exist (e.g., does not match an account number in the account information 162), the validation information may include information indicating an invalid account number. The error codes may be used to present information at the sending party device 110 or the agent device 130 to indicate a reason why the account was determined invalid. This may enable the respective users to correct the error, if possible, such as by providing the correct account number, correcting a typographical errors (e.g., a misspelled name or incorrect address), etc., and retransmit the request for account validation if desired.

The bank device 150 may transmit (e.g., using the communication interface 158) the validation information to the sending party device 110 (e.g., when the request 106 corresponds to the request 102) via the network 170, or to the agent device 130 (e.g., when the request 106 corresponds to the request 104) via the network 170, as indicated in FIG. 1 by validation data 180. The validation data 180 may be received (e.g., using the communication interface 118) at the sending party device 110 as validation data 184 (e.g., when the request 106 corresponds to the request 102), or may be received (e.g., using the communication interface 138) at the agent device 130 as validation data 182 (e.g., when the request 106 corresponds to the request 104).

The sending party device 110, or the agent device 130 may determine, based on the received validation information (e.g., the validation data 184 or the validation data 182, respectively) whether the account information associated with the receiving party, as provided by the sending party (e.g., using the user interface of the application at the sending party device 110 or as provided to the agent device 130), indicates a valid account. In response to a determination that the account associated with the receiving party is valid, the sending party device 110, or the agent device 130, may initiate the money transfer transaction between the sending party and the receiving party. Initiation of the money transfer transaction may cause funds to be deposited into the account associated with the receiving party.

In an aspect, the money transfer transaction may be initiated from the sending party device 110 or the agent device 130 in response to receiving an input indicating that the funds and a transaction fee have been collected from the sending party. The input indicating the funds and the transaction fee have been collected may be received via entry of a code via the user interface of the application (e.g., at the sending party device 110), via scanning of a barcode using an imaging device (e.g., a camera module of the sending party device 110, a barcode scanner coupled to or integrated with the agent device 130, etc.), via a message received from the money transfer entity (e.g., a message received at the sending party device 110 from the agent device 130 or the central server 172, a message received at the agent device 130 from the central server 172, or an input received at the agent device 130 from a user of the agent device 130), via an authorization received at the sending party device 110 or the agent device 130 from a financial card entity (e.g., a debit card or credit card authorization/processing entity), another input, or a combination thereof.

Initiating the money transfer transaction may include transmitting a money transfer request (MTR) to the bank device 150. For example, when the money transfer transaction is initiated from the sending party device 110, the request may be generated and sent to the bank device 150 as an MTR 190. As another example, when the money transfer transaction is initiated from the agent device 130, the request may be generated and sent to the bank device 150 as an MTR 192. The MTR (e.g., either the MTR 190 or the MTR 192) may be received at the bank device 150 as an MTR 194. In response to receiving the MTR 194, the bank device 150 may process the money transfer transaction and deposit the funds into the account associated with the receiving party.

In an aspect, the funds are deposited into the account associated with the receiving party by transferring the funds to the account from an account associated with the money transfer entity. For example, the money transfer entity may establish relationships with one or more banking entities (e.g., affiliate banks) and may also establish an account or line of credit at each affiliate bank. Thus, when the account of the receiving party is at an affiliate bank, the MTR 194 may be processed in real-time by transferring the funds to from the money transfer account at the affiliate bank to the account of the receiving party at the affiliate bank. Thus, the present disclosure provides for real-time account validation and funding of C2A transactions when valid account information is provided. Further aspects of providing for real-time account validation and funding of C2A transactions when invalid account information is provided are described below.

In response to a determination that the account associated with the receiving party is invalid, the sending party device 110, or the agent device 130, may initiate a request to create an account at the banking entity. For example, the user interface may present information indicating the candidate account information is invalid and may provide a prompt to the user of the sending party device 110. The prompt may offer the sending party an opportunity to create an account at the banking entity associated with the bank device 150 on behalf of the receiving party. In an aspect, if the bank device 150 that provided the validation information to the sending party device 110 is not an affiliate bank, the prompt may offer the sending party the opportunity to create an account on behalf of the receiving party at a banking entity that is not associated with the bank device 150, such as at an affiliate bank. Similar operations may be performed at the agent device 130.

The sending party device 110 or the agent device 130 may receive an input corresponding to a request to create a new account associated with the receiving party. In response to the input, the sending party device, or the agent device 130, may initiate transmission of a new account request (not shown in FIG. 1) to the bank device 150 (or another bank device). The new account request may include the candidate account information and may be configured to cause the bank device of the banking entity to create the new account on behalf of the receiving party.

The new account request may be received at the bank device 150, and the bank device 150 may, in response to the new account request, initiate creation of the new account based on the candidate account information. In an aspect, the new account created in response to the new account request may not be created as a complete bank account. For example, an account number of the new account may indicate that the account was opened by a party (e.g., the sending party) other than the account owner (e.g., the receiving party). Thus, prior to enabling withdrawal of funds from the new account, the account owner may need to provide additional information/fill out some paper work, etc. In response to creating the new account, the bank device may transmit a message including account information corresponding to the new account to the sending party device 110 or the agent device 130. The sending party device 110 or the agent device 130 may initiate money transfer transaction (e.g., transmit the MTR 190 or the MTR 192 to the bank device 150) based on the account information corresponding to the new account.

The bank device 150 may receive the MTR 194 including the account information corresponding to the new account, and may process the money transfer transaction (e.g., the C2A transaction) based on the account information corresponding to the new account. For example, the bank device 150 may deposit the funds into the new account. In an aspect, the funds are deposited into the new account in real-time. The funds may be deposited into the new account by transferring the funds to the new account from an account at the banking entity associated with the money transfer.

After completion of the funds transfer (e.g., the funds have been deposited in the account of the receiving party or the new account created on behalf of the receiving party), a confirmation number or other identifier may be provided to the sending party. In an aspect, the information provided to the bank device 150 includes a telephone number, an email address, or other contact information associated with the receiving party. In response to depositing funds into the receiving party's account, or creating the new account on behalf of the receiving party and depositing the funds into the new account, the bank device 150 may transmit information (e.g., a simple message service (SMS) message, a text message, an email message, an automated voice response system message, or another type of message) to the receiving party to indicate that the funds have been deposited into the account or that the account has been created.

When the account was determined to be a valid account, the receiving party may access the funds immediately (e.g., using an automated teller machine, a debit card, or other payment means) without visiting the banking entity. When the account was created on behalf of the receiving party, the receiving party may visit the banking entity to access the funds. For example, the receiving party may visit a location (e.g., a brick and mortar bank) provided by the banking entity and access the funds. The banking entity may provide the receiving party with several options for accessing the funds in the new account. For example, the receiving party may complete opening of the account by filling out any necessary paper work, such as for compliance with one or more banking regulations. Alternatively, the receiving party, upon authenticating his/her identity to the banking entity, may cash out the funds from the new account. The bank may charge a transaction fee for creating the new account and for depositing the funds in the new account. However, when the receiving party elects to complete the opening of the account (e.g., become a customer of the banking entity), the banking entity may reduce or waive the transaction fee. Thus, the system 100 facilitates real-time money transfer transactions (e.g., C2A transactions) despite a sending party providing incorrect or otherwise invalid bank account information associated with an account of the receiving party.

In an additional or alternative aspect, the system 100 may support a hybrid money transfer transactions, where the money transfer transaction is funded between a first money transfer entity location and a second money transfer entity location using a C2A transaction, but the receiving party receives funding of the money transfer transaction at the second money transfer location in cash, as opposed to a deposit into the receiving parties bank account. For example, the sending party may initiate the transaction at the first money transfer location (e.g., via an employee using the agent device 130) or at the sending party device 110. The sending party may indicate the second money transfer location as a location where the receiving party intends to receive the funds, and may initiate the money transfer transaction.

The agent device 130, the central server 172, or both, may detect the money transfer transaction and may determine whether the first money transfer location and the second money transfer location are associated with a same or different account (e.g., bank account). When the first money transfer location and the second money transfer location are associated with different accounts, such as when the first money transfer location is in a first geographic area (e.g., city, state, country, etc.) and the second money transfer location is in a second geographic area that is different from the first geographic area (e.g., a different city, a different state, a different country, etc.), the agent device 130, the central server 172, or both, may determine candidate account information associated with an account corresponding to the second money transfer location. The candidate account information associated with an account corresponding to the second money transfer location may be determined based on information stored at a database (not shown in FIG. 1) of the central server 172 or information stored in the database 140. The candidate account information may be used to initiate a C2A transaction that deposits funds into the account corresponding to the second money transfer location, and may be performed as described above. In response to depositing the funds into the account corresponding to the second money transfer location, the bank device 150 may provide information indicating the deposit to an agent device 130 at the second money transfer location, and providing authorization to release the funds to the receiving party at the second location in real-time. Thus, the system 100 may facilitate cash to cash transactions between money transfer entities operated by different entities (e.g., different individuals operating separate franchises of a money transfer entity or different money transfer entities), while providing assurance to the party providing the funds to the receiving party that the funds have been received at the party's account.

In an aspect, the sending party may provide the funds for the money transfer transaction to the employee operating the agent device 130. In an additional or alternative aspect, the sending party may use the application operating at the sending party device 110 to provide the funds for the money transfer transaction. For example, the funds may be provided based on payment information 126 stored in a database 120 at the memory 114 of the sending party device 110. The payment information 126 may include information identifying a prepaid amount of funds provided to the money transfer entity, information identifying a financial card (e.g., a debit card or a credit card) of the sending party, or other information (e.g., a code) indicating payment of the first amount of funds to the money transfer entity. In an aspect, initiating the money transfer transaction may include authenticating the transaction with the agent device 130 or the central server 172. For example, the application may communicate with the agent device 130 or the central server 172 via the network 170 to verify the prepaid amount of funds provided to the money transfer entity by the sending party, to verify the code, etc.

As shown in FIG. 1, the agent device 130 may include a database 140 stored at the memory 134 of the agent device 130. The database 140 may store account information 142 including information associated with one or more sending parties, one or more receiving parties, transaction history information 144, and payment information 146. The account information 142 may include information associated with individuals (e.g., customers of the money transfer entity) that have previously used the money transfer services provided by the money transfer entity. The transaction history information 144 may include a log of previously completed money transfer transactions. The payment information 146 may include information associated with any amounts of prepaid funds provided by one or more of the customers of the money transfer entity, a log of financial card transactions that have been processed by the money transfer entity, etc. The account information 142, the transaction history information 144, and the payment information 146 may be linked to facilitate monitoring of the money transfer transactions for suspicious or fraudulent activity and/or for auditing and government regulation compliance purposes.

In an aspect, the database 120 stored at the memory 114 of the sending party device 110 may store receiving party information 122, transaction history information 124, and payment information 126. The receiving party information 122 may include information associated with one or more individuals that the sending party has previously sent funds to, or desires to send funds to using the money transfer services of the money transfer entity. For a particular receiving party, the receiving party information 122 may include the candidate account information (e.g., a bank account number associated with an account of the particular receiving party, information identifying a name of a banking entity associated the account of the particular receiving party, a name of the particular receiving party, a routing number associated with the banking entity, etc.). The transaction history information 124 may store records of previously completed money transfer transactions between the sending party and the one or more receiving parties indicated by the receiving party information 122. In an aspect, the user interface of the application may present a selectable list of one or more candidate receiving parties at the display device of the sending party device 110. The sending party device may receiving an input indicating a selection of a first receiving party from the selectable list of one or more candidate receiving parties, and, in response to the input, retrieve candidate account information associated with the first receiving party from the receiving party information 122 stored at the database 120. The user interface may also include a selectable option to create a new entry in the receiving party information 122 (e.g., when the intended receiving party is not included in the selectable list).

In an aspect, the user interface of the application may be configured to receive an input indicating an amount of funds to be transferred during the money transfer transaction. The sending party device 110 may generate the request 102 based on the selection of the first receiving party from the selectable list and the input indicating the amount of funds to be transferred. In an aspect, the request 102 may be transmitted to the central server 172 and the central server 172 may then forward request to the bank device 150. In an aspect, the bank device may be an electronic device operated by the money transfer entity, such as the central server 172, rather than the banking entity. For example, the money transfer entity may establish a relationship with the banking entity (e.g., an affiliate bank), and the banking entity may provide the money transfer entity with access to a network (e.g., a private network) that enables the money transfer entity to perform real-time account validation services, as described above, using the account information 162.

By performing money transfer transactions and creating accounts using the system 100, a number of customers that perform money transfer transactions with the money transfer entity may be increased. Additionally, a relationship between the money transfer entity and the banking entity may be strengthened, leading to increased cross-product promotional opportunities that facilitate increased revenue for both the money transfer entity and the banking entity. Additionally, the convenience provided by enabling sending parties to create accounts on behalf of receiving parties may increase customer loyalty to the money transfer entity and the banking entity. Further, the system 100 may provide for real-time account validation and real-time funding of C2A transactions.

Additionally, by performing money transfer transactions and creating accounts using the system 100, customer satisfaction of the sending party may be increased. For example, because account validations are performed in real-time, the sending party receives real-time confirmation that the funds are available for access by the receiving party (e.g., when the account is a valid account). Additionally, when the account is not a valid account, the sending party may still provide the funds to the receiving party by creating a new account on behalf of the receiving party and receive real-time confirmation that the funds are available for access by the receiving party from the new account. This may increase the sending party's satisfaction with the money transfer services provided by the money transfer entity, and may increase the likelihood that the sending party will utilize the money transfer entity for subsequent money transfer transactions.

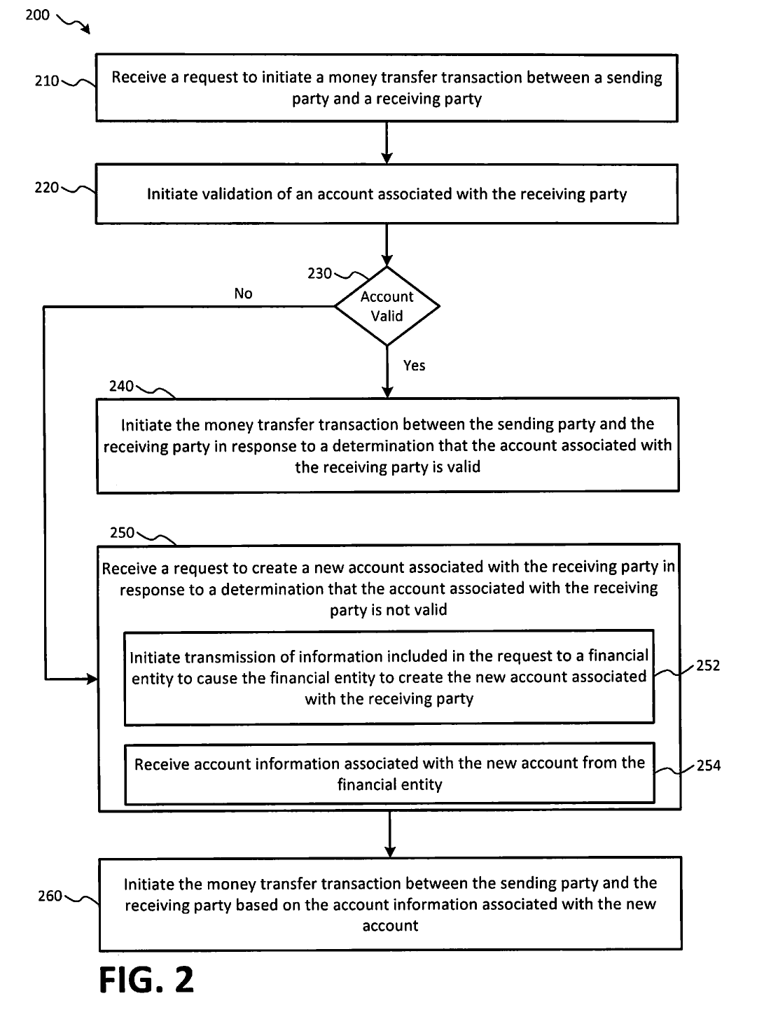

Referring to FIG. 2, a flow chart illustrating aspects of an exemplary method for performing a money transfer transaction at an agent device is shown and designated 200. In an aspect, the method 200 may be performed entirely or partially at the agent device 130 of FIG. 1, entirely or partially at the central server 172 of FIG. 1, or a combination thereof. At 210, the method 200 includes receiving a request to initiate a money transfer transaction between a sending party and a receiving party. The request may include information identifying an account associated with the receiving party. At 220, the method 200 includes initiating validation of the account associated with the receiving party. In an aspect, initiating validation of the account associated with the receiving party may include transmitting candidate account information (e.g., the request 104 of FIG. 1) to a bank device (e.g., the bank device 150 of FIG. 1). In an additional or alternative aspect, the validation of the account may be performed by a single device (e.g., an agent device 130 communicatively coupled to a database of account information, such as the account information 162 of FIG. 1).

At 230, the method 200 includes performing a determination as to whether the account associated with the receiving party is valid. At 240, the method 200 includes initiating the money transfer transaction between the sending party and the receiving party in response to a determination that the account associated with the receiving party is valid. The money transfer transaction may be initiated and funded as described with reference to FIG. 1. For example, initiation of the money transfer transaction may causes funds to be deposited into the account associated with the receiving party (e.g., from an account associated with a money transfer entity). In an aspect, the method 200 may include receiving an input indicating that the funds and a transaction fee have been collected from the sending party, and the funds may be deposited into the account associated with the receiving party in response to the input. In an aspect, the funds are deposited into the account associated with the receiving party in real-time.

At 250, the method 200 includes receiving a request to create a new account associated with the receiving party in response to a determination that the account associated with the receiving party is not valid. At 252, the method 200 may include initiating transmission of information included in the request to a financial entity (e.g., the banking device 150 of FIG. 1 associated with the banking entity) to cause the financial entity to create the new account associated with the receiving party. In an aspect, the information included in the request may include a name of the receiving party, an address of the receiving party, a telephone number associated with the receiving party, an email address associated with the receiving party, etc. The banking entity, or more particularly, an electronic device of the banking entity, such as the bank device 150 of FIG. 1, may receive the request and initiate creation of the account. The banking entity may transmit account information associated with the new account to the agent device 130 or the central server 172, as described with reference to FIG. 1.

At 254, the method 200 includes receiving account information associated with the new account from the financial entity. At 260, the method 200 includes initiating the money transfer transaction between the sending party and the receiving party based on the account information associated with the new account. Initiation of the money transfer transaction may cause funds to be deposited into the new account, as described with reference to FIG. 1. For example, initiation of the money transfer transaction may causes funds to be deposited into the new account associated with the receiving party (e.g., from an account associated with a money transfer entity). In an aspect, the method 200 may include receiving an input indicating that the funds and a transaction fee have been collected from the sending party, and the funds may be deposited into the new account in response to the input. In an aspect, the funds are deposited into the new account in real-time.

By performing money transfer transactions and creating accounts using the method 300, a number of customers that perform money transfer transactions with the money transfer entity may be increased. Additionally, a relationship between the money transfer entity and the banking entity may be strengthened, leading to increased cross-product promotional opportunities that facilitate increased revenue for both the money transfer entity and the banking entity. Additionally, the convenience provided by enabling sending parties to create accounts on behalf of receiving parties may increase customer loyalty to the money transfer entity and the banking entity. Further, the method 400 may provide for real-time account validation and real-time funding of C2A transactions.

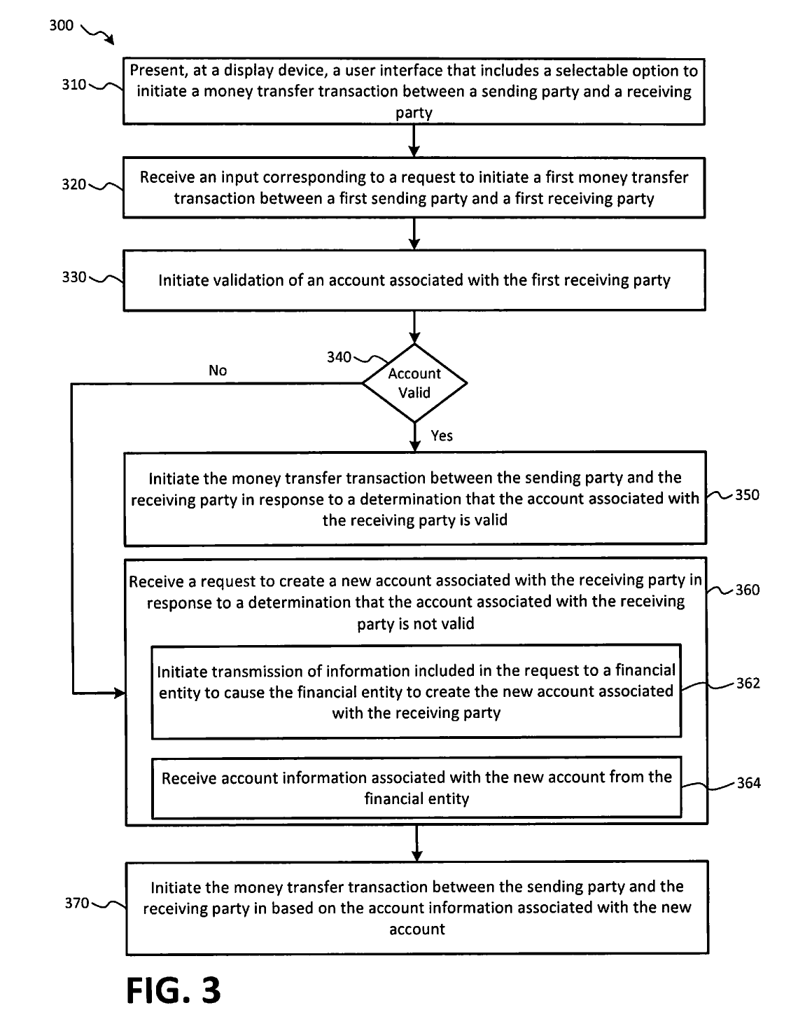

Referring to FIG. 3, a flow chart illustrating exemplary aspects of a method of initiating a money transfer transaction from a sending party device is shown and designated. In an aspect, the method 300 may be performed at the sending party device 110 of FIG. 1. At 310, the method 300 includes presenting, at a display device of an electronic device, a user interface. In an aspect, the user interface may be presented at a display device of the sending party device 110 of FIG. 1 (e.g., using the application described with reference to FIG. 1). The user interface may include a selectable option to initiate a money transfer transaction between a sending party and a receiving party.

At 320, the method 300 includes receiving an input corresponding to a request to initiate a first money transfer transaction between the sending party and the receiving party. The request may include information identifying an account associated with the receiving party. At 330, the method 300 includes initiating validation of the account associated with the receiving party. In an aspect, initiating the validation of the account may include transmitting an account validation request to a bank device (e.g., the bank device 150 of FIG. 1). In an additional or alternative aspect, initiating the validation of the account may include transmitting the account validation request to an electronic device of a money transfer entity (e.g., the agent device 130 or the central server 172).

At 340, the method 300 includes performing a determination of whether the account associated with the receiving party is valid. In an aspect, the determination may be performed based on information (e.g., the validation data 184 of FIG. 1) received from the bank device. In an additional or alternative aspect, the determination may be performed based on information received from the electronic device of the money transfer entity. In response to a determination that the account is valid, the method 300 includes, at 350, initiating the money transfer transaction between the sending party and the receiving party. Initiation of the money transfer transaction may cause funds to be deposited into the account associated with the receiving party, as described with reference to FIG. 1.

In response to a determination that the account associated with the receiving party is not valid, the method 300 includes, at 360, receiving a request to create a new account associated with the receiving party. In an aspect, the request to create the new account may be received via an input provided via a user interface of an application executing at the mobile device, as described with reference to FIG. 1. The request may include information identifying the receiving party, such as the receiving party's name, an address associated with the receiving party, an email address associated with the receiving party, a telephone number of the receiving party, etc., as described with reference to FIG. 1. At 362, the method 300 includes initiating transmission the request to create the new account to a financial entity (e.g., the banking entity and the bank device 150 of FIG. 1). The request may be configured to cause the financial entity to create the new account on behalf of the receiving party, as described with reference to FIG. 1. At 364, the method 300 includes receiving account information associated with the new account from the financial entity.

At 370, the method 300 includes initiating the money transfer transaction between the sending party and the receiving party based on the account information associated with the new account. Initiation of the money transfer transaction may cause funds to be deposited into the new account, as described with reference to FIG. 1. For example, initiation of the money transfer transaction may causes funds to be deposited into the new account associated with the receiving party (e.g., from an account associated with a money transfer entity). In an aspect, the method 300 may include receiving an input indicating that the funds and a transaction fee have been collected from the sending party, and the funds may be deposited into the new account in response to the input. The input indicating that the funds and the transaction fee have been collected may be received via entry of a code via the user interface, via scanning of a barcode using an imaging device of the sending party device 110 of FIG. 1, via a message received at the sending party device 110 of FIG. 1 from a money transfer entity, via an authorization received at the sending party device 110 of FIG. 1 from a financial card entity, or a combination thereof. In an aspect, the funds are deposited into the new account in real-time.

By performing money transfer transactions and creating accounts using the method 300, customer satisfaction of the sending party may be increased. For example, because account validations are performed in real-time, the sending party receives real-time confirmation that the funds are available for access by the receiving party (e.g., when the account is a valid account). Additionally, when the account is not a valid account, the sending party may still provide the funds to the receiving party by creating a new account on behalf of the receiving party and receive real-time confirmation that the funds are available for access by the receiving party from the new account. This may increase the sending party's satisfaction with the money transfer services provided by the money transfer entity, and may increase the likelihood that the sending party will utilize the money transfer entity for subsequent money transfer transactions.

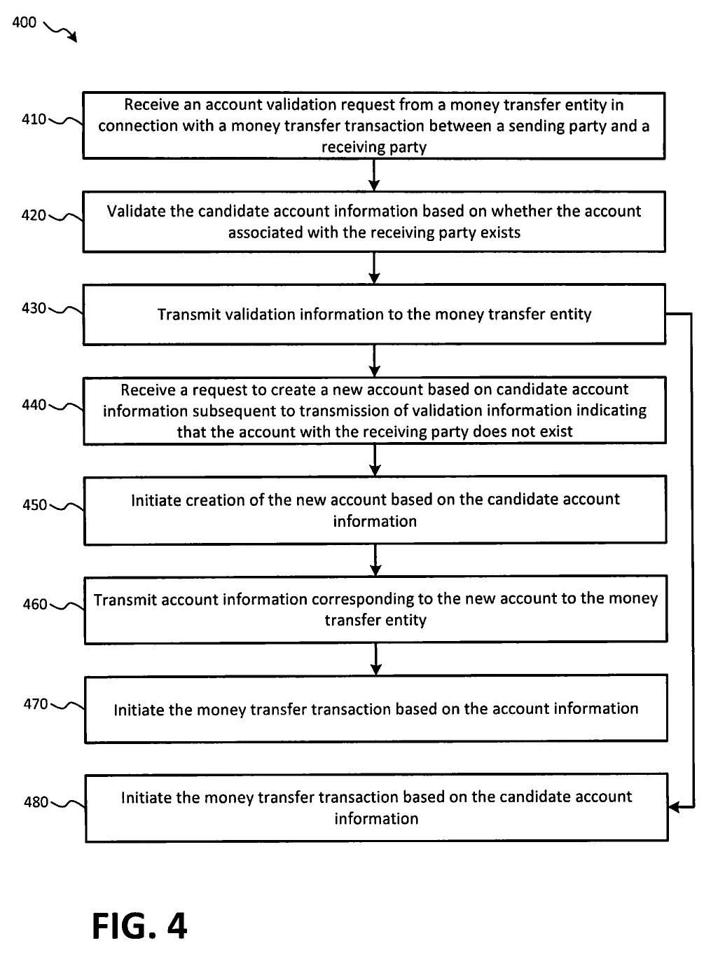

Referring to FIG. 4, a flow chart illustrating aspects of an exemplary method for creating an account in connection with a money transfer transaction is shown and designated 400. The method 400 may be performed by an electronic device (e.g., a computer, a server, etc.) associated with a financial entity (e.g., the banking entity described with reference to FIG. 1). In an aspect, the method 400 may be performed by the bank device 150 of FIG. 1.

At 410, the method 400 includes receiving an account validation request from a money transfer entity in connection with a money transfer transaction between a sending party and a receiving party. The account validation request may include candidate account information (e.g., the candidate account information described with reference to FIG. 1) associated with an account associated with the receiving party. At 420, the method 400 includes validating the candidate account information based on whether the account associated with the receiving party exists (e.g., is valid account at the financial entity). At 430, the method 400 includes transmitting validation information to the money transfer entity. The validation information may include an indication of whether the account associated with the receiving party is valid (e.g., is an existing account at the financial entity, is an account associated with the receiving party, etc.).

When the validation information includes an indication that the account associated with the receiving party is not valid (e.g., is not an existing account at the financial entity, is not an account associated with the receiving party, etc.), the method 400 includes, at 440, receiving a request to create a new account based on the candidate account information. At 450, the method 400 includes initiating creation of the new account based on the candidate account information. At 460, the method 400 includes transmitting account information corresponding to the new account to the money transfer entity. At 470, the method 400 includes initiating the money transfer transaction based on the account information. When the validation information includes an indication that the account associated with the receiving party is valid (e.g., is an existing account at the financial entity and is an account associated with the receiving party), the method 400 includes, at 480, initiating the money transfer transaction based on the candidate account information.

Initiating the money transfer transaction may include depositing funds into the account (e.g., the newly created account or an existing account) associated with the receiving party. An amount of the funds deposited into the new account may be determined based information received from the money transfer entity. In an aspect, the amount of the funds may be indicated in the candidate account information. In an additional or alternative aspect, the amount of the funds may be determined based on additional information received from the money transfer entity (e.g., a message received in response to providing the validation information indicating the account associated with the receiving party is valid). In an aspect, the funds may be deposited into the account from another account (e.g., an account associated with the money transfer entity) at the financial entity (e.g., the bank).

By performing money transfer transactions and creating accounts using the method 400, a number of customers that bank with the banking entity may be increased. Additionally, a relationship between the money transfer entity and the banking entity may be strengthened, leading to increased cross-product promotional opportunities that facilitate increased revenue for the money transfer entity and the banking entity. Additionally, the convenience provided by enabling sending parties to create accounts on behalf of receiving parties may increase customer loyalty to the money transfer entity and the banking entity. Further, the method 400 may provide for real-time account validation and real-time funding of C2A transactions.

It is appreciated that the above example cases may be implemented separately or in combination. Additionally, it is noted that one or more steps in the example flow processes of FIGS. 2-3 may be implemented in a differing order or omitted all together. It is noted that the functional blocks, modules and processes illustrated in FIGS. 1-4 may include or utilize processors (e.g., the processors 112, 132, 152 of FIG. 1, respectively), electronics devices (e.g., the sending party device 110, the agent device 130, the bank device 150, and the central server 172 of FIG. 1), hardware devices, electronics components, logical circuits, memories, software codes, firmware codes, etc., or any combination thereof.

Those of skill would further appreciate that the various illustrative logical blocks, modules, circuits, and algorithm steps described in connection with the present disclosure may be implemented as electronic hardware, computer software (e.g., the instructions 116, 136, 156 of FIG. 1, respectively), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system (e.g., the system 100). Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method (e.g., the method 200 of FIG. 2, the method 300 of FIG. 3, and the method 400 of FIG. 4) or algorithm described in connection with the present disclosure may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described in connection with FIGS. 1-4 may be implemented in hardware, software, firmware, or any combination thereof. When implemented in software, the functions may be stored on or transmitted over as one or more instructions (e.g., the instructions 116, 136, 156 of FIG. 1, respectively) or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Although aspects of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A method comprising:
receiving, by a processor, a request to initiate a money transfer transaction between a sending party and a receiving party, wherein the request includes information identifying an account associated with the receiving party;
initiating, by the processor, validation of the account associated with the receiving party; and
in response to a determination that the account associated with the receiving party is not valid, receiving a request to create a new account associated with the receiving party.

2. The method of claim 1, wherein the method includes initiating the money transfer transaction between the sending party and the receiving party in response to a determination that the account associated with the receiving party is valid, wherein initiation of the money transfer transaction causes funds to be deposited into the account associated with the receiving party, and wherein funds are deposited into the account associated with the receiving party in real-time.

3. The method of claim 2, wherein the funds are deposited into the account associated with the receiving party by transferring the funds to the account from an account associated with a money transfer entity, and wherein the account associated with the money transfer entity and the account associated with the receiving party correspond to financial accounts at a financial entity.

4. The method of claim 2, wherein the method includes receiving an input indicating that the funds and a transaction fee have been collected from the sending party, and wherein the funds are deposited into the account associated with the receiving party in response to the input.

5. The method of claim 1, wherein the method includes:
initiating transmission of information included in the request to create the new account to a financial entity to cause the financial entity to create the new account associated with the receiving party; and
initiating the money transfer transaction between the sending party and the receiving party, wherein initiation of the money transfer transaction causes funds to be deposited into the new account.

6. The method of claim 5, wherein the method includes receiving account information associated with the new account from the financial entity, wherein the money transfer transaction is initiated based on the account information associated with the new account.

7. The method of claim 5, wherein the method includes receiving an input indicating that the funds and a transaction fee have been collected from the sending party, and wherein the funds are deposited into the new account in response to the input.

8. The method of claim 5, wherein the funds are deposited into the new account in real-time.

9. The method of claim 8, wherein the funds are deposited into the new account in real-time by transferring the funds to the new account from an account associated with a money transfer entity, and wherein the account associated with the money transfer entity and the new account correspond to bank accounts at a same banking entity.

10. A system comprising:
a processor; and
a memory coupled to the processor, the memory storing instructions that, when executed by the processor, cause the processor to perform operations including:
receiving a request to initiate a money transfer transaction between a sending party and a receiving party, wherein the request includes information identifying an account associated with the receiving party;
initiating validation of the account associated with the receiving party; and
in response to a determination that the account associated with the receiving party is not valid, receiving a request to create a new account associated with the receiving party.

11. The system of claim 10, wherein the operations include initiating the money transfer transaction between the sending party and the receiving party in response to a determination that the account associated with the receiving party is valid, wherein initiation of the money transfer transaction causes funds to be deposited into the account associated with the receiving party, and wherein the funds are deposited into the account associated with the receiving party in real-time.

12. The system of claim 11, wherein the funds are deposited into the account associated with the receiving party in real-time by transferring the funds to the account from an account associated with a money transfer entity, and wherein the account associated with the money transfer entity and the account associated with the receiving party correspond to financial accounts at a financial entity.

13. The system of claim 11, wherein the operations include receiving an input indicating that the funds and a transaction fee have been collected from the sending party, and wherein the funds are deposited into the account associated with the receiving party in response to the input.

14. The system of claim 10, wherein the operations include:
initiating transmission of information included in the request to create the new account to a financial entity to cause the financial entity to create the new account associated with the receiving party; and
receiving account information associated with the new account from the financial entity, wherein the money transfer transaction is initiated based on the account information associated with the new account.

15. The system of claim 14, wherein the operations include initiating the money transfer transaction between the sending party and the receiving party, wherein initiation of the money transfer transaction causes funds to be deposited into the new account.

16. The system of claim 15, wherein the operations include receiving an input indicating that the funds and a transaction fee have been collected from the sending party, and wherein the funds are deposited into the new account in response to the input.

17. The system of claim 15, wherein the funds are deposited into the new account in real-time by transferring the funds to the new account from an account associated with a money transfer entity, and wherein the account associated with the money transfer entity and the new account correspond to bank accounts at a same banking entity.

18. A computer-readable storage device storing instructions that, when executed by a processor, cause the processor to perform operations including:
receiving a request to initiate a money transfer transaction between a sending party and a receiving party, wherein the request includes information identifying an account associated with the receiving party;
initiating validation of the account associated with the receiving party; and
receiving a request to create a new account associated with the receiving party in response to a determination that the account associated with the receiving party is not valid.

19. The computer-readable storage device of claim 18, wherein the operations include initiating the money transfer transaction between the sending party and the receiving party in response to a determination that the account associated with the receiving party is valid, wherein initiation of the money transfer transaction causes funds to be deposited into the account associated with the receiving party, and wherein the funds are deposited into the account associated with the receiving party in real-time.

20. The computer-readable storage device of claim 19, wherein the funds are deposited into the account associated with the receiving party in real-time by transferring the funds to the account from an account associated with a money transfer entity, and wherein the account associated with the money transfer entity and the account associated with the receiving party correspond to financial accounts at a financial entity.

21. The computer-readable storage device of claim 19, wherein the operations include receiving an input indicating that the funds and a transaction fee have been collected from the sending party, and wherein the funds are deposited into the account associated with the receiving party in response to the input.

22. The computer-readable storage device of claim 18, wherein the operations include:
initiating transmission of information included in the request to a financial entity to cause the financial entity to create the new account associated with the receiving party; and
receiving account information associated with the new account from the financial entity, wherein the money transfer transaction is initiated based on the account information associated with the new account.

23. The computer-readable storage device of claim 22, wherein the operations include initiating the money transfer transaction between the sending party and the receiving party, wherein initiation of the money transfer transaction causes funds to be deposited into the new account.

24. The computer-readable storage device of claim 23, wherein the operations include receiving an input indicating that the funds and a transaction fee have been collected from the sending party, and wherein the funds are deposited into the new account in response to the input.

25. The computer-readable storage device of claim 23, wherein the funds are deposited into the new account in real-time by transferring the funds to the new account from an account associated with a money transfer entity, and wherein the account associated with the money transfer entity and the new account correspond to bank accounts at a same banking entity.

26. A computer-readable storage device storing instructions that, when executed by a processor, cause the processor to perform operations including:
presenting, at a display device, a user interface, wherein the user interface includes a selectable option to initiate a money transfer transaction between a sending party and a receiving party;
receiving an input corresponding to a request to initiate a first money transfer transaction between a first sending party and a first receiving party, wherein the request includes information identifying an account associated with the first receiving party;
initiating validation of the account associated with the first receiving party; and
receiving a request to create a new account associated with the first receiving party in response to a determination, based on the validation, that the account associated with the first receiving party is not valid.

27. The computer-readable storage device of claim 26, wherein the operations include:
transmitting the information identifying the account associated with the first receiving party to an account validation entity; and
receiving account validity information from the account validation entity, wherein the determination that the account associated with the first receiving party is valid is based on the account validity information.

28. The computer-readable storage device of claim 26, wherein the operations include:
presenting a selectable list of one or more candidate receiving parties that includes the first receiving party;
receiving a second input indicating a selection of the first receiving party from the selectable list of one or more candidate receiving parties; and
in response to the second input, retrieving an entry from a database, wherein the entry includes the information identifying the account associated with the first receiving party based on.

29. The computer-readable storage device of claim 28, wherein the determination that the account associated with the first receiving party is valid is based on the information identifying the account associated with the first receiving party.

30. The computer-readable storage device of claim 26, wherein the operations include:
initiating transmission of the request to create the new account to a financial entity, wherein the request includes information identifying the first receiving party, and wherein the request is configured to cause the financial entity to create the new account; and
receiving account information associated with the new account from the financial entity, wherein the money transfer transaction is initiated based on the account information associated with the new account.

31. The computer-readable storage device of claim 30, wherein the operations include initiating the money transfer transaction between the first sending party and the first receiving party, wherein initiation of the money transfer transaction causes funds to be deposited into the new account.

32. The computer-readable storage device of claim 31, wherein the operations include receiving information indicating that the funds and a transaction fee have been collected from the sending party, and wherein the funds are deposited into the new account associated with the first receiving party in response to the input.

33. The computer-readable storage device of claim 26, wherein the operations include initiating the money transfer transaction between the first sending party and the first receiving party in response to a determination that the account is valid, wherein initiation of the money transfer transaction causes funds to be deposited into the account, wherein the funds are deposited into the account by transferring the funds to the account from an account associated with a money transfer entity, and wherein the account associated with the money transfer entity and the account associated with the first receiving party correspond to financial accounts at a financial entity.

34. The computer-readable storage device of claim 32, wherein the information indicating the funds and the transaction fee have been collected is received via entry of a code via the user interface, via scanning of a barcode using an imaging device of an electronic device, via a message received at the electronic device from a money transfer entity, via an authorization received at the electronic device from a financial card entity, or a combination thereof.

35. A computer-readable storage device storing instructions that, when executed by a processor, cause the processor to perform operations comprising:
receiving, from a money transfer entity, an account validation request, wherein the account validation request is received in connection with a money transfer transaction between a sending party and a receiving party, and wherein the account validation request includes candidate account information associated with an account associated with the receiving party;
validating the candidate account information based on whether the account associated with the receiving party exists;
transmitting, to the money transfer entity, validation information, wherein the validation information includes an indication of whether the account associated with the receiving party is valid; and
subsequent to transmission of validation information indicating that the account with the receiving party does not exist, receiving a request to create a new account based on the candidate account information.

36. The computer-readable storage device of claim 35, wherein the operations include:
initiating creation of the new account based on the candidate account information;
transmitting account information corresponding to the new account to the money transfer entity; and
initiating the money transfer transaction based on the account information.

37. The computer-readable storage device of claim 36, wherein the operations include:
receiving an input indicating whether the creation of the new account is to be completed or canceled; and
determining a transaction fee based on the input.

38. The computer-readable storage device of claim 37, wherein the operations include:
in response to the input indicating that the creation of the new account is to be completed, completing the creation of the new account, wherein funds provided in connection with the money transfer transaction are available for withdrawal from the new account subsequent to completing creation of the new account; and
in response to the input indicating that the creation of the new account is to be canceled:
canceling the creation of the new account; and
providing the funds received in connection with the money transfer transaction to the receiving party,
wherein the funds available for withdrawal from the new account or the funds provided to the receiving party are reduced by an amount corresponding to the transaction fee.

39. The computer-readable storage device of claim 37, wherein the transaction fee is reduced when the input indicates that the receiving party wants to complete the creation of the new account.
